(19) United States
(12) Patent Application Publication
(10) Pub. No.: US 2010/0208460 A1
(43) Pub. Date: Aug. 19, 2010

(54) LUMINAIRE WITH LED ILLUMINATION CORE

(75) Inventors: Christopher Ladewig, Fayetteville, GA (US); Gregg Lehman, Peachtree City, GA (US)

Correspondence Address: King & Spalding, 1100 Louisiana, suite 4000, Houston, TX, 77002, US

(73) Assignee: Cooper Technologies Company

(21) Appl. No.: 12/708,389

(22) Filed: Feb. 18, 2010

Related U.S. Application Data
(60) Provisional application No. 61/153,797, filed on Feb. 19, 2009.

(51) Int. Cl. F21V 1/00; F21S 4/00

(52) U.S. Cl. 362/235; 362/249.02; 362/218

(57) ABSTRACT

A luminaire includes a housing, at least one core member coupled to the housing, at least one LED positioned on the core member, and at least one heat sink thermally coupled to the LEDs. The core member includes a first end, a second end, and a body extending from the first end to the second end. The body's outer surface includes one or more receiving surfaces spaced apart and operable to receive one or more LEDs. LEDs can be added, removed, or repositioned on the receiving surfaces to change the light distribution. The cooling system includes either an integral heat sink, an external heat sink, or both. The core member is designed to increase lighting efficiency by directing more light away from a direction opposite the intended area of illumination.

### CROSS REFERENCE TO RELATED APPLICATIONS

The present application claims priority from U.S. Provisional Patent Application No. 61/153,797, entitled “Luminaire With LED Illumination Core” and filed on Feb. 19, 2009, the entire contents of which are hereby incorporated herein by reference.

The present application is related to U.S. patent application Ser. No. 12/494,944, titled “Light Emitting Diode Lamp Source,” filed Jun. 30, 2009, U.S. patent application Ser. No. 12/183,499, titled “Light Fixture With An Adjustable Optical Distribution,” filed Jul. 31, 2008, U.S. patent application Ser. No. 12/183,490, titled “Heat Management For A Light Fixture With An Adjustable Optical Distribution,” filed Jul. 31, 2008, and U.S. Provisional Patent Application No. 60/994,371, titled “Flexible Light Emitting Diode Optical Distribution,” filed Sep. 19, 2007. The complete disclosure of each of the related applications is hereby fully incorporated herein by reference.

### FIELD OF THE INVENTION

The present invention relates generally to luminaires. More specifically, the invention relates to a luminaire having a light emitting diode (“LED”) core member for producing light and cooperative cooling system.

### BACKGROUND

A luminaire is a system for producing, controlling, and/or distributing light for illumination. For example, a luminaire includes a system that outputs or distributes light into an environment, thereby allowing certain items in that environment to be more visible. Luminaires are used in indoor or outdoor applications.

A typical luminaire includes a device having one or more light emitting elements that are electrically coupled to a power supply. The light emitting elements are either removable or non-removable depending upon the application and cost considerations. Some typical luminaires also include one or more sockets, connectors, or surfaces configured to position and connect the light emitting elements to a power supply, an optical device configured to distribute light from the light emitting elements, and mechanical components for supporting or suspending the luminaire. Luminaires are sometimes referred to as “lighting fixtures” or as “light fixtures.” A light fixture that has a socket, connector, or surface configured to receive a light emitting element, but no light emitting element installed therein, is still considered a luminaire. That is, a light fixture lacking some provision for full operability still fits the definition of a luminaire. The term “light emitting element” is used herein to refer to any device configured to emit light, such as a lamp or an LED.

Optical devices are configured to direct light energy emitted by light emitting elements into one or more desired areas. For example, optical devices may direct light energy through reflection, diffusion, baffling, refraction, or transmission through a lens. Lamp placement within the light fixture also plays a significant role in determining light distribution. For example, a horizontal lamp orientation typically produces asymmetric light distribution patterns, and a vertical lamp orientation typically produces symmetric light distribution patterns.

Different lighting applications require different optical distributions. For example, a lighting application in a large, open environment may require a symmetric, square distribution that produces a wide, symmetrical pattern of uniform light. Another lighting application in a smaller or narrower environment may require a non-square distribution that produces a focused pattern of light. For example, the amount and direction of light required from a light fixture used on a street pole depends on the location of the pole and the intended environment to be illuminated.

Conventional light fixtures are configured to only output light in a single, predetermined distribution. To change an optical distribution in a given environment having a conventional fixture, a person must remove the existing light fixture and install a new light fixture with a different optical distribution. These steps are cumbersome, time consuming, wasteful, and expensive.

Additionally, in conventional lamps, such as light bulbs, incandescent lamps, and high intensity discharge (“HID”) lamps, light is emitted in a spherical pattern. Inside conventional luminaires using these conventional lamps, the light that is emitted away from the luminaire opening must be redirected to the opening with multiple reflective surfaces. Each time light is reflected, there is approximately a ten percent loss of efficiency. Additionally, some light will be reflected back into the lamp and lost.

### SUMMARY

One exemplary embodiment includes a luminaire. The luminaire can include a housing, at least one core member, at least one light emitting diode (“LED”), and at least one heat sink. The housing can include an inner surface and an exterior surface. The core member is coupled to and disposed along the inner surface of the housing and can include a first end, a second end, a body, and at least one receiving surface. The body can extend between the first end and the second end. The receiving surfaces can be spaced along at least a portion of an outer surface of the body and are operable to receive one or more LEDs. The heat sink can be thermally coupled to the LEDs.

Another exemplary embodiment includes a method for adjusting an optical distribution of a luminaire. The method can include providing a luminaire and adjusting an optical distribution of the luminaire. The luminaire can include a housing, at least one core member, at least one light emitting diode (“LED”), and at least one heat sink. The housing can include an inner surface and an exterior surface. The core member is coupled to and disposed along the inner surface of the housing and can include a first end, a second end, a body, and at least one receiving surface. The body can extend between the first end and the second end. The receiving surfaces can be spaced along at least a portion of an outer surface of the body and are operable to receive one or more LEDs. The heat sink can be thermally coupled to the LEDs. The optical distribution of the luminaire can be adjustable by removing at least one of the LEDs from a respective receiving surface, repositioning at least one of the LEDs with respect to its receiving surface and/or coupling at least one additional LED to at least one of the receiving surfaces.

Another exemplary embodiment includes a luminaire. The luminaire can include a housing, at least one core member, at least one light emitting diode (“LED”), and at least one heat sink. The housing can include an interior surface and an opposing exterior surface. The core member is coupled to and disposed along the interior surface of the housing and can include a first end, a second end, a longitudinally extending body, and at least one receiving surface. The body can include an arc-shaped outer surface and can extend between the first end and the second end. The receiving surfaces can be spaced along at least a portion of the outer surface and are operable to receive a plurality of LEDs. At least a portion of the heat sink can be integrally formed with and disposed along a top surface of the core member. Additionally, at least a portion of the heat sink can be in thermal communication with the LEDs.

### BRIEF DESCRIPTION OF THE DRAWINGS

For a more complete understanding of the present invention and the advantages thereof, reference is now made to the following description, in conjunction with the accompanying figures briefly described as follows:

FIG. 1 is a side perspective view of a luminaire, according to one exemplary embodiment of the present invention;

FIG. 2 is another perspective view of the luminaire of FIG. 1, presenting an internal view of the luminaire and an LED core member, according to one exemplary embodiment of the present invention;

FIG. 3 is a cross-sectional view of the luminaire of FIG. 1, according to one exemplary embodiment of the present invention;

FIG. 4 is a perspective view of another exemplary luminaire coupled to a mounting structure, according to an alternative exemplary embodiment of the present invention; and

FIG. 5 is a side elevation view of the luminaire of FIG. 4, according to one exemplary embodiment of the present invention.

The drawings illustrate only exemplary embodiments of the invention and are therefore not to be considered limiting of its scope, as the invention may admit to other equally effective embodiments.

### DETAILED DESCRIPTION OF THE EXEMPLARY EMBODIMENTS

The present invention is directed to luminaires. In particular, the application is directed to a luminaire having a light emitting diode (“LED”) core member for producing light and cooperative cooling system. The invention may be better understood by reading the following description of non-limiting, exemplary embodiments with reference to the attached drawings, wherein like parts of each of the figures are identified by like reference characters, and which are briefly described as follows.

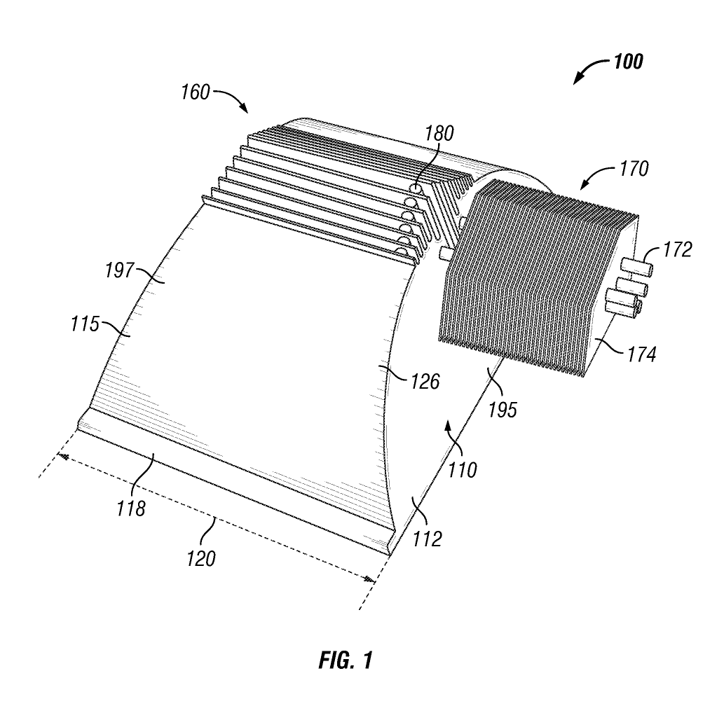

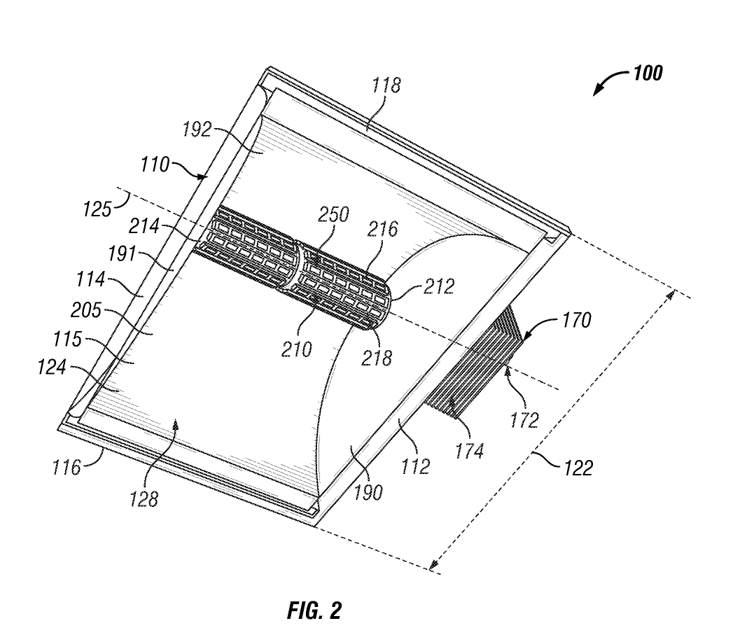

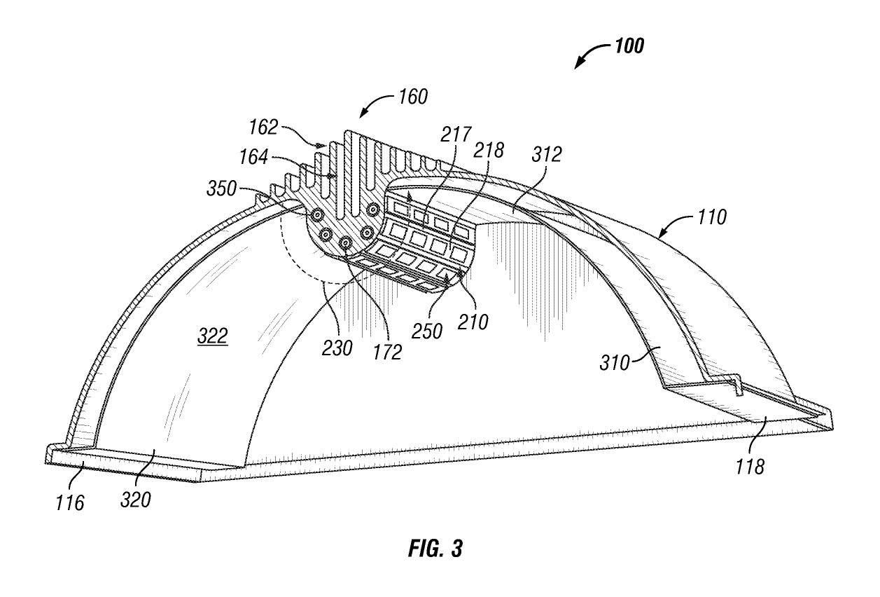

Referring now to the drawings, in which like numerals represent like elements throughout the drawings, aspects of the exemplary embodiments of the present invention are described. FIG. 1 is a side perspective view of a luminaire 100, according to one exemplary embodiment of the present invention. FIG. 2 is another perspective view of the luminaire 100, presenting an internal view of the luminaire 100 and an LED core member 210, according to one exemplary embodiment of the present invention. FIG. 3 is a cross-sectional view of the luminaire 100, according to one exemplary embodiment of the present invention. Referring now to FIGS. 1-3, the luminaire 100 includes a housing 110, an LED core member 210, and a heat sink 160 or 170.

In one exemplary embodiment, the housing 110 is substantially rectangularly-shaped; however, other shapes are within the scope and spirit of this disclosure based on the desired use and light output from the luminaire 100. The exemplary housing 110 includes an adjacent end 112, a distal end 114, and a top surface 115 having two longitudinal ends 116 and 118. In one exemplary embodiment, each longitudinal end 116 and 118 is coupled to both the adjacent end 112 and the distal end 114. The exemplary top surface 115 is arcuate-shaped, but can be other shapes including, but not limited to, flat. The housing 110 has a length 120 defined by the distance between the adjacent end 112 and the distal end 114 and a width 122 defined by the distance between the two longitudinal ends 116 and 118. The adjacent end 112 includes an inner surface 190 and an exterior surface 195. The distal end 114 includes an inner surface 191 and an exterior surface (not shown). The top surface 115 includes an inner surface 192 and an exterior surface 197. Inner surfaces 190, 191, and 192 of the adjacent end 112, the distal end 114, and the top surface 115 are collectively referred to as a housing inner surface 124. Similarly, exterior surfaces 195 and 197 of the adjacent end 112, the distal end 114, and the top surface 115 are collectively referred to as a housing exterior surface 126.

In certain exemplary embodiments, at least a portion of the inner surface 124 is reflective, which allows at least a portion of the light emitted from the LED core member 210, which is discussed in further detail below, to exit the luminaire 100 and proceed toward a desired area to be illuminated. Alternatively, in other exemplary embodiments, a reflector 310 is positioned within the housing 110 to direct at least a portion of the light emitted from the LED core member 210 out of the luminaire 100 and proceed toward a desired area to be illuminated. According to some exemplary embodiments, two reflectors 310 and 320 are mounted within the housing 110 according to methods known to people having ordinary skill in the art. Each reflector 310 and 320 has an arcuate shape and extends from the LED core member 210 towards the respective longitudinal end 116 and 118. As those of ordinary skill in the art will recognize, the shape and number of the reflectors 310 and 320 in FIG. 3 are not intended to be limiting and many different reflector shapes and number of reflectors are substitutable based on the desired light output of the luminaire. Additionally, the inner surfaces 312 and 322 of the reflectors 310 and 320 are fabricated from a reflective material, such as aluminum, or finished into a reflective finish according to methods known to people having ordinary skill in the art.

The housing 110 is shaped to form a cavity 205 with a luminaire opening 128 positioned substantially in an area bounded by the adjacent end 112, the distal end 114, and the two longitudinal ends 116 and 118. The luminaire opening 128 allows light emitted from the LED core member 210 to exit the luminaire 100 and proceed toward a desired area to be illuminated. Although the housing 110 is substantially rectangularly-shaped in an exemplary embodiment, the housing 110 can be shaped into any geometric shape including, but not limited to, square-shaped, circular-shaped, elliptical-shaped, and hexagonal-shaped, or any non-geometric shape in alternative exemplary embodiments. According to these exemplary embodiments, the adjacent end 112 is considered to be adjacent to a mounting structure, such as an arm, while the distal end 114 is considered to be opposite the adjacent end 112 and distal from the mounting structure. The housing 110 is fabricated using die-cast aluminum or any other material known to people having ordinary skill in the art.

The LED core member 210 includes a first end 212, a second end 214, and a body 216 extending between the first end 212 and the second end 214. In one exemplary embodiment, the LED core member 210 is integrally formed on the inner surface 124 of the housing 110 via molding, casting, extrusion, die-based material processing, or other means for forming a surface on a material that is known to a person of ordinary skill in the art having the benefit of the present disclosure; however, according to other exemplary embodiments, the LED core member 210 is separately formed from the inner surface 124 of the housing 110 and thereafter coupled to the inner surface 124 of the housing 110 using screws, rivets, adhesives, or other fastening means known to people having ordinary skill in the art. In some exemplary embodiments, the LED core member 210 extends longitudinally along at least a portion of a center axis 125 of the top surface's inner surface 192, which is substantially parallel to the length 120 of the housing 110. In other exemplary embodiments, multiple LED core members 210 extend longitudinally or latitudinally along the top surface's inner surface 192, either on or off the center axis 125. In certain alternative exemplary embodiments, at least one LED core member 210 is substantially parallel to another LED core member 210. In certain other alternative exemplary embodiments, the first end 212 is integrally coupled to the inner surface 190 of the adjacent end 112. In some exemplary embodiments, the first end 212 is integrally coupled to the inner surface 190 of the adjacent end 112 and the second end 214 is integrally coupled to the inner surface 191 of the distal end 114. In some exemplary embodiments, at least a portion of the body 216 is integrally coupled to the inner surface 192 of the top surface 115.

The body 216 includes an outer surface 217 having one or more receiving surfaces 218, or facets, spaced along at least a portion of an outer surface 217 of the body 216. The outer surface 217 extends substantially radially forming an angle 230 of about 180 degrees. However, in certain exemplary embodiments, the angle 230 ranges from five degrees to about 360 degrees. Exemplary embodiments include the LED core member's outer surface 217 being shaped such that less light is emitted from the LED core member 210 towards a direction opposite the luminaire opening 128, thereby increasing light output efficiency and thermal efficiency because less light is directed opposite the luminaire opening 128. As previously mentioned, each time light is reflected, there is approximately a ten percent loss in efficiency and a chance that some light will be reflected back into the lamp and also lost to heat. Each facet 218 includes a substantially flat, curved, angular, textured, recessed, protruding, bulbous, and or other shaped surface. In one exemplary embodiment, the facets 218 are formed integrally to the LED core member 210. In one exemplary embodiment, the integral facets 218 are formed on the LED core member 210 via molding, casting, extrusion, die-based material processing, or other means for forming a surface on a material that are known to a person of ordinary skill in the art having the benefit of the present disclosure. For example, the LED core member 210 and the facets 218 are made of die-cast aluminum or any other material known to people having ordinary skill in the art. In certain alternative exemplary embodiments, the LED core member 210 and facets 218 include separate components coupled together to form the LED core member 210. For example, in one exemplary embodiment, the facets 218 are mounted or attached to the outer surface 217 of the LED core member 210 by solder, braze, welds, glue, plug-and-socket connections, epoxy, rivets, clamps, fasteners, or other attachment means known to people having ordinary skill in the art.

Each facet 218 is operable to receive at least one or more LEDs, LED packages (having multiple LEDs thereon), or linear LED strips (hereinafter referred collectively as LEDs 250). The LEDs 250 are capable of being arranged in various different positions along the facets 218 to adjust the overall direction and intensity of the distribution of light from the LED core member 210. This flexibility in arrangement and configuration of the LEDs 250 allows the luminaire 100 to have many different optical distributions. Manipulation of the positions of LEDs 250 on the facets 218 allows the luminaire 100 to have any type of light distribution, such as a symmetric or asymmetric type I, II, III, IV, or V light distribution.

Positioning multiple LEDs 250 in the same facet 218 increases directional intensity of the light relative to the facet 218, as compared to a facet 218 with only one or no LEDs 250. For example, positioning the LEDs 250 in a linear array along the facet 218 increases directional intensity of the light substantially normal to the axis of the facet 218. Directional intensity also is capable of being adjusted by increasing or decreasing the electrical power to one or more of the LEDs 250. For example, overdriving one or more LEDs 250 increases the directional intensity of the light from the LEDs 250 in a direction normal to the corresponding facet 218. Similarly, using LEDs 250 with different sizes and/or wattages adjusts directional intensity. For example, replacing an LED 250 with another LED 250 that has a higher wattage increases the directional intensity of the light from the LEDs 250 in a direction normal to the corresponding facet 218.

The optical distribution of the luminaire 100 is adjusted by changing the output direction and/or intensity of one or more LEDs 250. In other words, the optical distribution of the luminaire 100 is adjusted not only by the shape of the interior surfaces 190, 191, 192, 312, and 322 of the housing 100 and/or the reflectors 310 and 320 but also by mounting additional LEDs 250 to the LED core member 210 along particular facets 218, removing one or more LEDs 250 from the LED core member 210, and/or by changing the position and/or the configuration of one or more of the LEDs 250. For example, repositioning one or more of the LEDs 250 in a different facet 218, in a different location along the same facet 218, removing one or more LEDs 250 from one or more facets 218 on the LED core member 210, or reconfiguring to have a different level of electrical power, will adjust the overall light distribution of the luminaire 100. Thus, the luminaire 100 is adjustable in a manner such that any number of optical distributions are achievable with the same luminaire 100.

The LEDs 250 are mounted to the facets 218 (and/or LED core member 210) by solder, braze, welds, glue, plug-and-socket connections, epoxy, rivets, clamps, fasteners, or other means known to a person of ordinary skill in the art having the benefit of the present disclosure. Each LED 250 is mounted to its respective facet 218 directly or via a substrate (not shown) that includes one or more sheets of ceramic, metal, laminate, or another material, such as a printed circuit board (“PCB”) or a metal core printed circuit board (“MPCB”). For example, each LED 250 can be attached to its respective substrate by a solder joint, a plug, an epoxy or bonding line, or another suitable provision for mounting an electrical/optical device on a surface. Similarly, if a substrate is not used, one or more circuitry elements (not shown) of each LED 250 can be attached directly to its respective facet 218 by a solder joint, a plug, an epoxy or bonding line, or another suitable provision for mounting an electrical/optical device on a surface.

In one exemplary embodiment the LED core member 210 has a radius of about 1.0 inch thereby forming the outer surface 217. According to certain exemplary embodiments, the radius is variable, thereby forming a partial elliptical shape, or any other geometric or non-geometric shape, for the outer surface 217. Additionally, in one exemplary embodiment, the LED core member 210 has a total of seven facets 218. The size of the LED core member 210 and the number of facets 218 is capable of being varied depending on the size of the LEDs 250, the size of the luminaire 100, manufacturing tolerances for casting or molding, cost considerations, and other financial, operational, and/or environmental factors known to a person of ordinary skill in the art having the benefit of the present disclosure. As will be readily apparent to a person of ordinary skill in the art, a larger number of facets 218 corresponds to a higher level of flexibility in adjusting the optical distribution of the luminaire 100. In particular, the greater the number of facets 218 on the LED core member 210, the greater the number of LED 250 positions, and thus optical distributions, available.

In certain exemplary embodiments, the LED core member 210 is hollow and defines a channel (not shown) that extends at least partially along the longitudinal axis of the LED core member 210. The channel houses one or more wires (not shown) electrically coupled between the LEDs 250 and a driver (not shown), thereby shielding the wires from view. The driver supplies electrical power to, and controls operation of, the LEDs 250. For example, the wires couple opposite ends of each substrate or other circuitry elements associated with each LED 250 to the driver, thereby completing one or more circuits between the driver and LEDs 250. In certain exemplary embodiments, the driver is configured to separately control one or more portions of the LEDs 250 to adjust light color and/or intensity. In certain alternative exemplary embodiments, there are multiple drivers that each control one or more of the LEDs 250 on one or more facets 218 or portions of facets 218. For example, in this exemplary embodiment, each driver controls the LEDs 250 on one of the facets 218.

The heat sink 160 or 170 is thermally coupled to at least a portion of the LED core member 210 and is either directly and/or indirectly coupled to the LED core member 210. The heat sink 160 or 170 includes an integral heat sink 160 and/or an external heat sink 170. The integral heat sink 160 is coupled directly to the LED core member 210, the top surface 115, the adjacent surface 112, and the distal surface 114 by incorporating the integral heat sink 160 into or directly coupling the integral heat sink 160 to the LED core member 210 and having the integral heat sink 160 disposed inside of or along the exterior surface 126 of the luminaire housing 110. In one exemplary embodiment, the integral heat sink 160, the LED core member 210, the top surface 115, the adjacent surface 112 and the distal surface 114 are integrally formed together is a single casting or molding process. For example, the integral heat sink 160, the housing 110, and LED core member 210 are integrally formed through an extrusion process. In this exemplary embodiment, the housing 110, the LED core member 210, and the integral heat sink 160 are formed from the same material, such as, for example die-cast aluminum.

In certain exemplary embodiments, the integral cooling system 160 includes multiple fins 162 disposed in a substantially parallel manner that are in thermal communication with the LED core member 210. The fins 162 extend along the exterior surface 197 of the top surface 115 and are located adjacent the LED core member's body 216. In certain exemplary embodiments, the fins 162 also extend on the exterior surface 195 of the adjacent end 112 and/or the exterior surface of the distal end 114. In one exemplary embodiment, the integral heat sink 160 includes multiple fins 162, each fin 162 operable to dissipate through a combination of conduction and convection at least a portion of the heat that is generated by the LEDs 250. In certain exemplary embodiments, the fins 162 extend longitudinally along at least a portion of the length 120 of the housing 110; however, according to other exemplary embodiments, the fins 162 extend latitudinally or at other angles along at least a portion of the length of the housing 110. In some exemplary embodiments, an air gap 164 is disposed between each of the fins 162 to allow for air flow to pass through and between one or more of the fins 162 and remove heat from the fins 162 through convection.

According to some exemplary embodiments, the integral heat sink 160 further includes one or more active cooling modules 180, such as a SYNJET™ brand module offered by Nuventix, Inc, which is coupled to the luminaire 100. In some exemplary embodiments, the active cooling modules 180 are coupled to one or more fins 162 and are operable to generate an air flow to increase the amount of air flowing between the fins and increase the amount of convective cooling that takes place between the fins 162. Each active cooling module 180 expels high momentum pulses of air for spot cooling the fins 162 and/or other components of the luminaire 100.

In certain exemplary embodiments, the external heat sink 170 is coupled indirectly to the LED core member 210 and the housing 110 and includes one or more heat pipes 172 and one or more sheet fins 174 positioned outside of the housing 110. However, in certain exemplary embodiments, the sheet fins 174 are positioned within the housing 110 without departing from the scope and spirit of the exemplary embodiment. The heat pipes 172 provide a pathway for transferring at least a portion of the heat built up in the LED core member 210 to the sheet fins 174. Each heat pipe 172 includes a first end disposed within the body of the LED core member 210. Heat pipes 172 extend from the LED core member 210, substantially parallel to the longitudinal axis of the LED core member 210, towards the sheet fins 174 and to a distal second end, which is positioned outside of the housing 110. However, according to some exemplary embodiments, the distal second end is positioned within the housing, but outside of the body 216 of the LED core member 210. At least a portion of each heat pipe 172 is inserted into a passageway 350, or void, in the LED core member 210 and surrounded by a portion of the LED core member 210 so that an outside perimeter of the heat pipe 172 engages an inside surface of the LED core member 210. In one exemplary embodiment, each heat pipe 172 includes a sealed pipe or tube made of a thermally conductive material, such as copper or aluminum. A cooling fluid (not shown), such as water, ethanol, acetone, sodium, or mercury, is disposed inside the heat pipes 172. In certain exemplary embodiments, the cooling fluid includes components, known to people having ordinary skill in the art, for reducing corrosion within the heat pipes 172. Evaporation and condensation of the cooling fluid causes thermal energy to transfer from a first, higher temperature portion of the heat pipe 172 (proximate one or more corresponding LEDs 250) to a second, lower temperature portion of the heat pipe 172 (away from the one or more corresponding LEDs 250).

The transferred heat is dissipated from the heat pipe 172 through convection and/or conduction. In one exemplary embodiment, the number and size of the heat pipes 172 depends on the desired amount of heat energy to be dissipated, the size of the LED core member 210, cost considerations, and other financial, operational, and/or environmental factors known to a person of ordinary skill in the art having the benefit of the present disclosure. In certain exemplary embodiments, one or more sheet fins 174 are coupled to each heat pipe 172 or coupled around the collection of heat pipes 172 to help dissipate the transferred heat.

According to some exemplary embodiments, the external heat sink 170 further includes one or more active cooling modules 180, such as a SYNJET™ brand module offered by Nuventix, Inc., coupled to one or more of the heat pipes 172. In some exemplary embodiments, the active cooling modules 180 are coupled to one or more heat pipes 172 or sheet fins 174 and are operable to generate an air flow to increase the amount of air flowing between the heat pipes and/or sheet fins and increase the amount of convective cooling that takes place between the heat pipes 172 and/or the sheet fins 174. Each active cooling module 180 expels high momentum pulses of air for spot cooling the heat pipes 172 and/or other components of the luminaire 100.

In certain exemplary embodiments, the exemplary luminaire 100 includes multiple circuits that enable the manipulation of light being output between areas directed towards a street and other areas directed towards a residence, such as a house or apartment. Further, in certain exemplary embodiments, the exemplary driver of the luminaire 100 includes a closed-loop feedback system to prevent excessive thermal temperatures within the luminaire 100 or within a predetermined proximity to the LEDs 250 to prolong LED 250 life and light output quality.

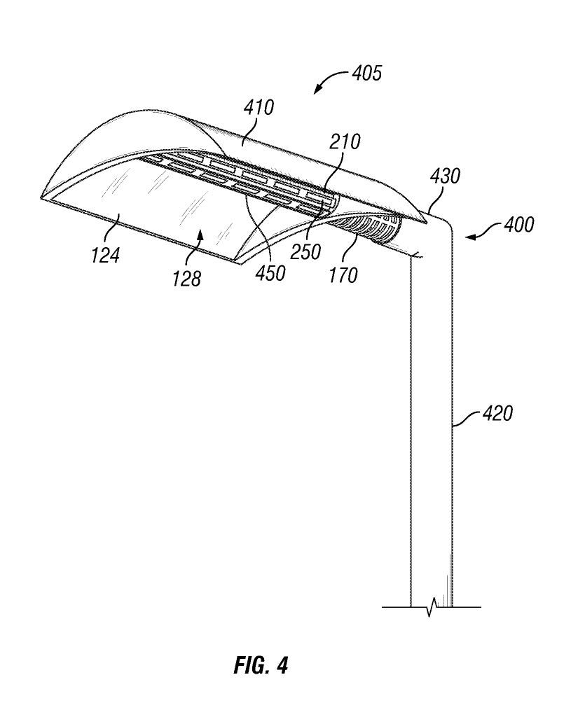

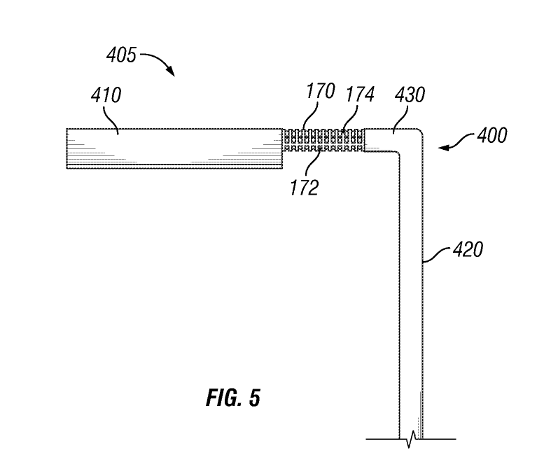

FIG. 4 is a perspective view of an alternative luminaire 405 coupled to a mounting structure 400, according to one exemplary embodiment of the present invention. FIG. 5 is a side elevation view of the luminaire 405 of FIG. 4. Referring to FIGS. 4 and 5, the luminaire 405 includes a housing 410, the LED core member 210, and the external heat sink 170, which are substantially similar to the housing 110, the LED core member 210, and the external heat sink 170 of FIGS. 1-3. According to this exemplary embodiment, the luminaire 405 also includes a lens 450 disposed over the LED core member 210 to collectively encapsulate the LEDs 250. The lens 450 is coupled to a portion of the inner surface 124 of the housing 410 or to a portion of the LED core member 210 using brackets (not shown) or other fasteners that are known to people having ordinary skill in the art. In one exemplary embodiment, the lens 450 is fabricated from an optically transmissive material or clear material including, but not limited to, plastic, glass, silicone, or other material known to people having ordinary skill in the art. According to certain exemplary embodiments, the lens 450 encapsulates at least some of the LEDs 250 individually. In yet other exemplary embodiments, the lens 450 is coupled to the housing 410 and/or other component of the luminaire 405 and covers the entire luminaire opening 128. The lens 450 provides environmental protection while allowing light emitted by the LEDs 250 to pass therethrough toward a desired area. In certain other exemplary embodiments, the lens 450 focuses light toward the desired area and create a desired light distribution. In certain exemplary embodiments, the lens 450 diffuses the light emitted from the LEDs 250. In yet another exemplary embodiments, the lens 450 creates an insulation between the internal components of the luminaire 405 and human contact, which can thereby allow usage of a higher voltage power supply to the luminaire 405.

The external heat sink 170 shown in FIGS. 4 and 5 includes one or more heat pipes 172 coupled to one or more sheet fins 174 that is positioned exterior to the housing 410. In the exemplary embodiment, the luminaire 405 is coupled to the mounting structure 400, which includes a pole 420 and an arm 430. In alternative exemplary embodiments, the mounting structure 400 includes the arm 430, but not the pole 420. In certain exemplary embodiments, the heat pipes 172 extend from the LED core member 210 to a distance beyond the sheet fins 174. The portion of the heat pipes 172 that extend beyond the sheet fins 174 are inserted within the arm 430 that surrounds this portion of the heat pipes 172. Thus, the extended portion of the heat pipes 172 provide support for coupling the luminaire 405 to the arm 430. Accordingly, in certain exemplary embodiments, the sheet fins 174 visually form part of the arm 430 and have an outer perimeter that is substantially similar to the outer perimeter of the arm 430. These exemplary embodiments provide the sheet fins 174 to be coupled to the arm 430 in an aesthetic manner. However, the outer perimeter of the sheet fins 174 can be greater or less than the outer perimeter of the arm 430 without departing from the scope and spirit of the exemplary embodiment.

Although the invention has been described with reference to specific embodiments, these descriptions are not meant to be construed in a limiting sense. Various modifications of the disclosed embodiments, as well as alternative embodiments of the invention will become apparent to persons of ordinary skill in the art upon reference to the description of the exemplary embodiments. It should be appreciated by those of ordinary skill in the art that the conception and the specific embodiments disclosed may be readily utilized as a basis for modifying or designing other structures or methods for carrying out the same purposes of the invention. It should also be realized by those of ordinary skill in the art that such equivalent constructions do not depart from the spirit and scope of the invention as set forth in the appended claims. It is therefore, contemplated that the claims will cover any such modifications or embodiments that fall within the scope of the invention.

What is claimed is:

1. A luminaire, comprising:
a housing comprising an inner surface and an exterior surface;
at least one core member coupled to and disposed along the inner surface of the housing, the core member comprising:
a first end;
a second end;
a body extending between the first end and the second end; and
at least one receiving surface spaced along at least a portion of an outer surface of the body, the receiving surface operable to receive a plurality of light emitting diodes (“LEDs”);
at least one LED, wherein each LED is coupled to one of the receiving surfaces; and
at least one heat sink thermally coupled to the LEDs.

2. The luminaire of claim 1, wherein the core member is integrally formed with the inner surface of the housing.

3. The luminaire of claim 1, wherein the heat sink is integrally formed with the housing and the core member and disposed along the exterior surface of the housing.

4. The luminaire of claim 3, wherein the heat sink comprises one or more fins extending along the exterior surface of the housing, the fins being positioned adjacent and in thermal communication with the body.

5. The luminaire of claim 4, wherein the fins extend longitudinally along at least a potion of the length of the housing.

6. The luminaire of claim 3, further comprising at least one active cooling module, each active cooling module being coupled to, and generating an air flow along the heat sink.

7. The luminaire of claim 1, wherein the heat sink comprises an external heat sink, the external heat sink comprising at least one heat pipe comprising a first end disposed within the body of the core member and extending from the core member to a distal second end outside of the body of the core member.

8. The luminaire of claim 7, wherein at least a portion of each heat pipe is surrounded by an inside surface of the body of the core member.

9. The luminaire of claim 7, wherein the external heat sink further comprises one or more sheet fins in thermal communication with the heat pipe and disposed outside of the body of the core member.

10. The luminaire of claim 9, wherein the luminaire is coupled to a mounting structure comprising an arm, the sheet fins being coupled with the arm, wherein outer circumference of the sheet fins is similar to the outer circumference of the arm.

11. The luminaire of claim 7, further comprising at least one active cooling module, each active cooling module being coupled to, and generating an air flow along the external heat sink.

12. The luminaire of claim 1, wherein the inner surface of the housing is reflective.

13. The luminaire of claim 1, further comprising at least one lens disposed between the LEDs and an area being illuminated.

14. The luminaire of claim 1, wherein the outer surface of the core member extends substantially radially forming an angle ranging between about five degrees and about 240 degrees.

15. A method for adjusting an optical distribution of a luminaire, comprising the steps of:
providing the luminaire comprising:
a housing comprising an inner surface and an exterior surface;
at least one core member coupled to and disposed along the inner surface of the housing, the core member comprising:
a first end;
a second end;
a body extending between the first end and the second end; and
at least one receiving surface spaced along at least a portion of an outer surface of the body, the receiving surface operable to receive a plurality of light emitting diodes (“LEDs”);
at least one LED, wherein each LED is coupled to one of the receiving surfaces; and
at least one heat sink thermally coupled to the LEDs, and adjusting an optical distribution of the luminaire by at least one of:
removing at least one of the LEDs from its respective receiving surface;
repositioning at least one of the LEDs with respect to its respective receiving surface; and
coupling at least one additional LED to at least one of the receiving surfaces.

16. The method of claim 15, wherein the core member is integrally formed with the inner surface of the housing.

17. The method of claim 15, wherein the heat sink is integrally formed with the housing and the core member and disposed along the exterior surface of the housing.

18. The method of claim 15, wherein the heat sink comprises an external heat sink, the external heat sink comprising at least one heat pipe comprising a first end disposed within the body of the core member and extending from the core member to a distal second end outside of the body of the core member.

19. The method of claim 18, wherein the external heat sink further comprises one or more sheet fins in thermal communication with the heat pipe and disposed outside of the body of the core member.

20. The method of claim 15, wherein the outer surface of the core member extends substantially radially forming an angle ranging between about five degrees and about 240 degrees.

21. A luminaire, comprising:
a housing comprising an interior surface and an opposing exterior surface;
at least one core member coupled to and disposed along the interior surface of the housing, each core member comprising:
a first end;
a second end;
a longitudinally extending body comprising an arc-shaped outer surface extending between the first end and the second end; and
at least one receiving surface spaced along at least a portion of the outer surface, the receiving surfaces being operable to receive a plurality of light emitting diodes (“LEDs”);
at least one LED, wherein each LED is coupled to one of the receiving surfaces; and
at least one heat sink, wherein at least a portion of the heat sink is integrally formed with and disposed along a top surface of the core member and in thermal communication with the LEDs.

22. The luminaire of claim 21, wherein the core member is integrally formed with the inner surface of the housing.

23. The luminaire of claim 21, wherein at least a second portion of the heat sink is integrally formed with and extends upward from the top surface of the housing.

24. The luminaire of claim 21, wherein the outer surface of the body extends substantially radially forming an angle between 150 and 190 degrees.

25. The luminaire of claim 21, wherein the heat sink comprises one or more fins extending along the exterior surface of the housing.

26. The luminaire of claim 21, wherein the luminaire comprises a second heat sink comprising at least one heat pipe comprising a first end extending through at least a portion of the body of the core member and a second distal end disposed outside of the body of the core member.

27. The luminaire of claim 26, further comprising one or more heat sink fins disposed outside of the body of the core member and in thermal communication with at least one heat pipe.
